(19) United States
(12) Patent Application Publication
(10) Pub. No.: US 2020/0167076 A1
(43) Pub. Date: May 28, 2020

(54) COMPRESSED MEMORY ACCESS IMPROVEMENT THROUGH COMPRESSION-AWARE PARTIAL WRITES

(71) Applicant: ATI Technologies ULC, Markham (CA)

(72) Inventors: Leon King Nok Lai, Markham (CA); Qian Ma, Markham (CA); Jimshed B. Mirza, Markham (CA)

(73) Assignee: ATI Technologies ULC, Markham (CA)

(21) Appl. No.: 16/200,573

(22) Filed: Nov. 26, 2018

(51) Int. Cl. G06F 3/06; G06F 12/0875; G06F 9/38

(52) U.S. Cl. CPC G06F 3/064; G06F 3/0611; G06F 12/0875; G06F 2212/401; G06F 9/3877; G06F 3/0683; G06F 3/0655

(57) ABSTRACT

A technique for improving performance of a data compression system is provided. The technique is applicable to compressed data sets that include compression blocks. Each compression block may be either compressed or uncompressed. Metadata indicating whether compression blocks are actually compressed or not is stored. If compression blocks are not compressed, then a read-decompress-modify-compress-write pipeline is bypassed. Instead, a compression unit writes the data specified by the partial request into the compression block, without reading, decompressing, modifying, recompressing, and writing the data, resulting in a much faster operation.

### BACKGROUND

Some data is stored in a compressed format to provide processing improvements such as reduced memory bandwidth consumption. However, there are tradeoffs associated with using compressed data. For example, although compressing data can reduce memory bandwidth, there is an associated increase in processing overload. Thus balancing the various tradeoffs associated with data compression is important.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 illustrates details of the device of FIG. 1, according to an example;

FIG. 3 is a block diagram showing additional details of the graphics processing pipeline illustrated in FIG. 2;

FIG. 4 illustrates a compression system for improved partial writes to a compressed data set, according to an example;

FIGS. 5A-5B illustrate operations of a compression system for compression blocks, according to an example; and

FIG. 6 is a flow diagram of a method for performing a partial write to a compressed data set that stores compression blocks that may be either compressed or uncompressed, according to an example.

### DETAILED DESCRIPTION

A technique for improving performance of a data compression system is provided. The technique is applicable to compressed data sets that include compression blocks. Each compression block may be either compressed or uncompressed. Specifically, each compression block is generated by processing uncompressed data with a compression algorithm. Based on the data, the compression algorithm either determines that a compressed version of the data would be smaller than the data or larger than the data. If a compressed version of the data would be smaller than the data, then the compression algorithm generates a compression block for the data that is a compressed version of the data. If a compressed version of the data would not be smaller than the data, then the compression algorithm generates a compression block that is an uncompressed version of the data—in such a situation, the compression block simply stores the raw data as a compression block.

In some situations, a client requests a partial write to a compression block. A partial write is a request to write data to the compression block, where the data requested to be written is less than all of the data represented by the compression block. A simple implementation of a system that performs partial writes would be one in which no distinction is made between compression blocks that actually store compressed data and compression blocks that store uncompressed data. In such a system, all partial writes to compression blocks would be processed as follows. A compression unit fetches a compression block. The compression unit applies a decompression algorithm to the compression block to obtain a decompressed block. If the compression block is actually compressed, then the decompression algorithm transforms the compressed data to provide decompressed data. If the compression block is not compressed, then the output of the decompression algorithm is the same as the input. Subsequent to this decompression, the compression unit applies the data requested to be written to the output of the decompression block. Then the compression unit applies a compression algorithm to the modified data to generate a modified compression block. If the compression algorithm determines that “compressed” data would actually be larger than the uncompressed data, then the result of the compression algorithm is the same as the input to the compression algorithm. If the compression algorithm determines that the compressed data would be smaller than the uncompressed data, then the result of the compression algorithm is a compressed version of the input to the compression algorithm. The above implementation is “simple” because the pipeline for making partial writes to compression blocks is the same regardless of whether the compression block to which the partial write is applied is actually compressed or not.

An improvement, described in greater detail herein, is to store metadata indicating whether compression blocks are actually compressed or not. If compression blocks are not compressed, then the read-decompress-modify-compress-write pipeline is bypassed. Instead, the compression unit simply writes the data specified by the partial request into the compression block, resulting in a much faster operation.

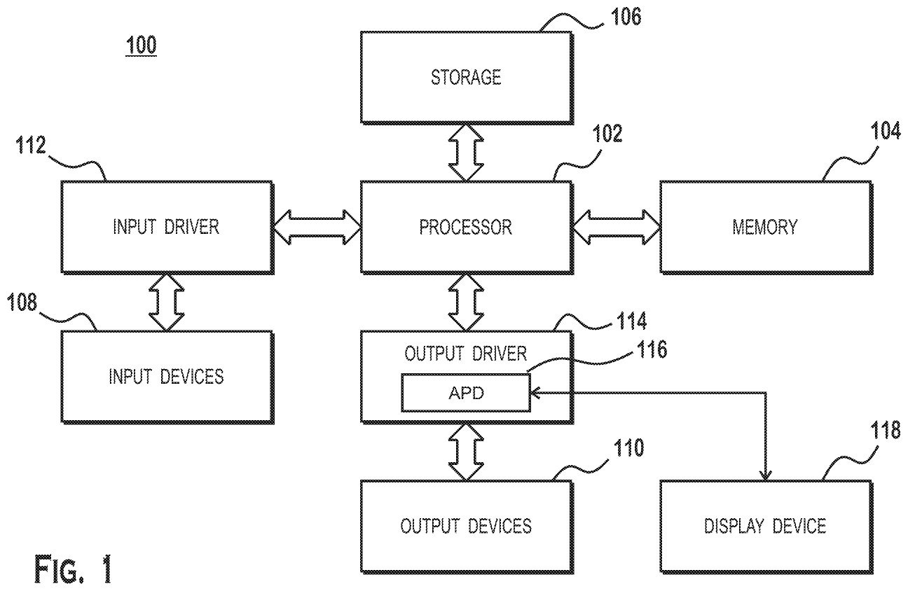

FIG. 1 is a block diagram of an example device 100 in which one or more features of the disclosure can be implemented. The device 100 could be one of, but is not limited to, for example, a computer, a gaming device, a handheld device, a set-top box, a television, a mobile phone, a tablet computer, or other computing device. The device 100 includes a processor 102, a memory 104, a storage 106, one or more input devices 108, and one or more output devices 110. The device 100 also includes one or more input drivers 112 and one or more output drivers 114. Any of the input drivers 112 are embodied as hardware, a combination of hardware and software, or software, and serve the purpose of controlling input devices 112 (e.g., controlling operation, receiving inputs from, and providing data to input drivers 112). Similarly, any of the output drivers 114 are embodied as hardware, a combination of hardware and software, or software, and serve the purpose of controlling output devices 114 (e.g., controlling operation, receiving inputs from, and providing data to output drivers 114). It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, without limitation, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 and output driver 114 include one or more hardware, software, and/or firmware components that are configured to interface with and drive input devices 108 and output devices 110, respectively. The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. The output driver 114 includes an accelerated processing device (“APD”) 116 which is coupled to a display device 118, which, in some examples, is a physical display device or a simulated device that uses a remote display protocol to show output. The APD 116 is configured to accept compute commands and graphics rendering commands from processor 102, to process those compute and graphics rendering commands, and to provide pixel output to display device 118 for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and configured to provide graphical output to a display device 118.

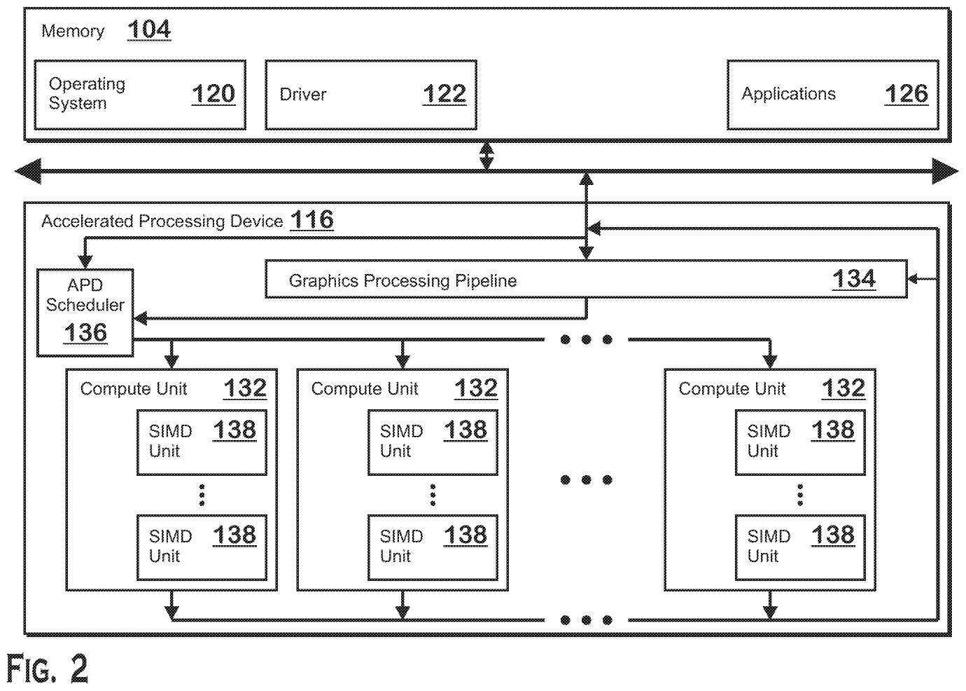

FIG. 2 illustrates details of the device 100 and the APD 116, according to an example. The processor 102 (FIG. 1) executes an operating system 120, a driver 122, and applications 126, and may also execute other software alternatively or additionally. The operating system 120 controls various aspects of the device 100, such as managing hardware resources, processing service requests, scheduling and controlling process execution, and performing other operations. The APD driver 122 controls operation of the APD 116, sending tasks such as graphics rendering tasks or other work to the APD 116 for processing.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that are configured to perform operations at the request of the processor 102 (or another unit) in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously (or partially simultaneously and partially sequentially) as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed on a single SIMD unit 138 or on different SIMD units 138. Wavefronts can be thought of as the largest collection of work-items that can be executed simultaneously (or pseudo-simultaneously) on a single SIMD unit 138. “Pseudo-simultaneous” execution occurs in the case of a wavefront that is larger than the number of lanes in a SIMD unit 138. In such a situation, wavefronts are executed over multiple cycles, with different collections of the work-items being executed in different cycles. An APD scheduler 136 is configured to perform operations related to scheduling various workgroups and wavefronts on compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

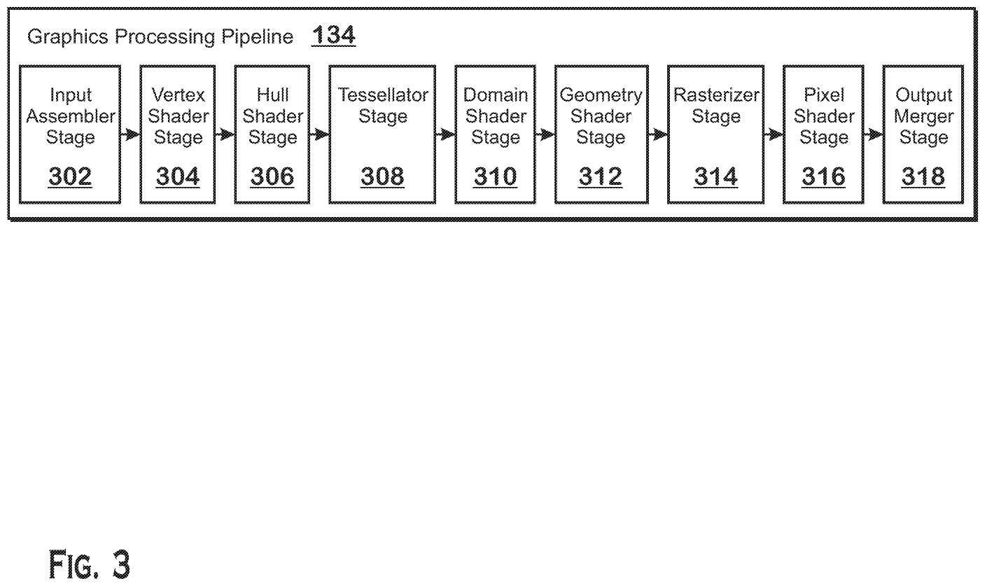

FIG. 3 is a block diagram showing additional details of the graphics processing pipeline 134 illustrated in FIG. 2. The graphics processing pipeline 134 includes stages that each performs specific functionality of the graphics processing pipeline 134. Each stage is implemented partially or fully as shader programs executing in the programmable compute units 132, or partially or fully as fixed-function, non-programmable hardware external to the compute units 132.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertices of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations, which modify vertex coordinates, and other operations that modify non-coordinate attributes.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the compute units 132, that are compiled by the driver 122 as with the vertex shader stage 304.

The geometry shader stage 312 performs vertex operations on a primitive-by-primitive basis. A variety of different types of operations can be performed by the geometry shader stage 312, including operations such as point sprite expansion, dynamic particle system operations, fur-fin generation, shadow volume generation, single pass render-to-cubemap, per-primitive material swapping, and per-primitive material setup. In some instances, a geometry shader program that is compiled by the driver 122 and that executes on the compute units 132 performs operations for the geometry shader stage 312.

The rasterizer stage 314 accepts and rasterizes simple primitives (triangles) generated upstream from the rasterizer stage 314. Rasterization consists of determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a pixel shader program that is compiled by the driver 122 and that executes on the compute units 132.

The output merger stage 318 accepts output from the pixel shader stage 316 and merges those outputs into a frame buffer, performing operations such as z-testing and alpha blending to determine the final color for the screen pixels.

The APD 116 includes a number of caches whose purpose it is to reduce the latency required to access data. Some caches are designated as being compressed. Other caches store at least some data of compressed groups of data. A compressed group of data is a logical grouping of data, where all blocks in that group of data have the potential to be compressed. The term “compressed data set” as used herein refers either to caches that are designated as being compressed or groups of data designated as being compressed. Individual compression elements

A compressed data set, despite being deemed “compressed,” may include some uncompressed data. Specifically, the compressed data set includes a plurality of compression blocks, where each compression block is processed by the same compression algorithm. Each compression block represents a “unit” of compression. A compression block represents the result of a compression algorithm when applied to the smallest amount of data that the compression algorithm can work on.

Each compression block may include either compressed or non-compressed data. More specifically, the compression algorithm accepts raw data and attempts to compress the raw data into a format that is smaller than the raw data. If the compression algorithm is able to compress the raw data into a format that is smaller than the raw data, then the compression algorithm does so to generate a compression block that has compressed data. If the compression algorithm is unable to compress the raw data into a format that is smaller than the raw data, then the compression algorithm generates a compression block that stores the raw data.

In some situations, a partial write is to occur to a compression block. A partial write is a write of data to a compression block, where less than all of the data in the compression block is being written. In one implementation, a compression controller fetches the compression block and applies a decompression algorithm to the compression block to obtain decompressed data. Then, the compression controller modifies the portion of the decompressed data as specified by the partial write. Then, the compression controller applies the compression algorithm to obtain a result and store the result.

Note that according to the above implementation, if a compression block is not compressed, then the act of reading the whole block, decompressing the block, and re-applying the compression algorithm to the compression block, represents wasted effort. More specifically, if the compression block is not compressed, then there is no need to apply the decompression algorithm, as the input and output of the decompression algorithm would be the same.

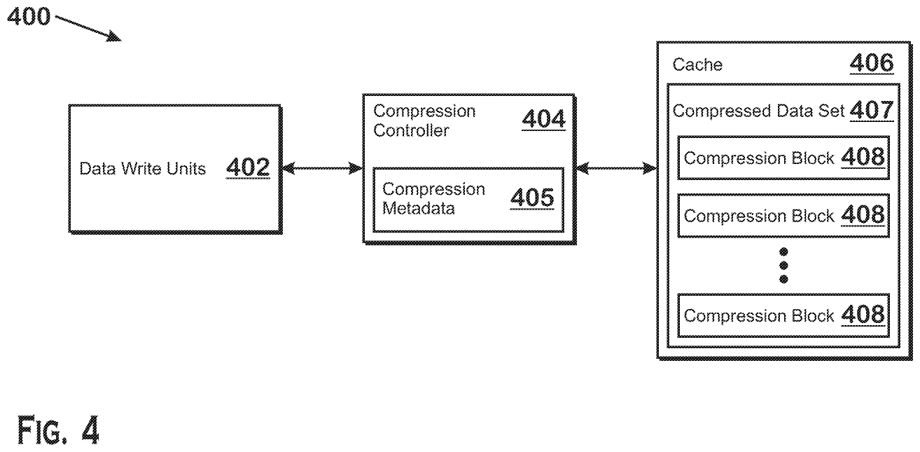

Therefore, FIG. 4 provides a compression system 400 for improved partial writes to a compressed data set 408, according to an example. The compression system 400 includes one or more data write units 402, a compression controller 404 that stores compression metadata 405, and a compressed data set 407 that includes compression blocks 408. The data write units 402 comprise one or more units that request writes of data into the compressed data set 407. An example of a data write unit 402 includes a SIMD unit 138 writing data to the compressed data set 407 under the control of a shader program.

The compression controller 404 is a hardware circuitry unit that acts as a compression-aware intermediary between the data write units 402 and the compressed data set 407. Specifically, the compression controller 404 accepts requests to write data from the data write units 402 and performs compression-related operations to write the data from the data write units 402. It should be understood that the compression controller 404 also performs actions related to requests other than writes, but that such actions are not discussed herein.

The cache 406 is a cache memory that, in various implementations, resides in the APD 116 or externally to the APD 116. The compressed data step 407 is either a logical collection of compression blocks 408 that at least partially resides in the cache 406, or is the cache itself 406, where the cache is designated as being a compressed cache. One example of a logical collection of compressed blocks 408 is a compressed render target. A render target is a buffer in memory that is designated to receive the pixel colors output by the graphics processing pipeline 134. In an example, a render target is the frame buffer, which is the buffer from which pixels are provided to a display device for display. Another example is a texture written to in render-to-texture mode. In such a mode, the graphics processing pipeline 134 outputs pixel results to a texture and the texture can subsequently be used for any purpose. In both of the above examples, the render target may be designated as compressed, in which case the render target would be a compressed data set 407.

The compression blocks 408 are individual units of compressed data that represent the smallest units of data that are generated by a single invocation of the compression algorithm implemented by the compression controller 404. In an example, the compression algorithm is a delta color compression algorithm that compresses color data by storing colors of nearby groups of pixels as the difference between color values for different color channels (e.g., red, green, blue, and alpha). The compression blocks 408 are units of data output by the delta color compressor.

The compression controller 404 maintains compression metadata 405. The compression metadata 405 indicates whether the data in any particular compression block 408 is actually compressed.

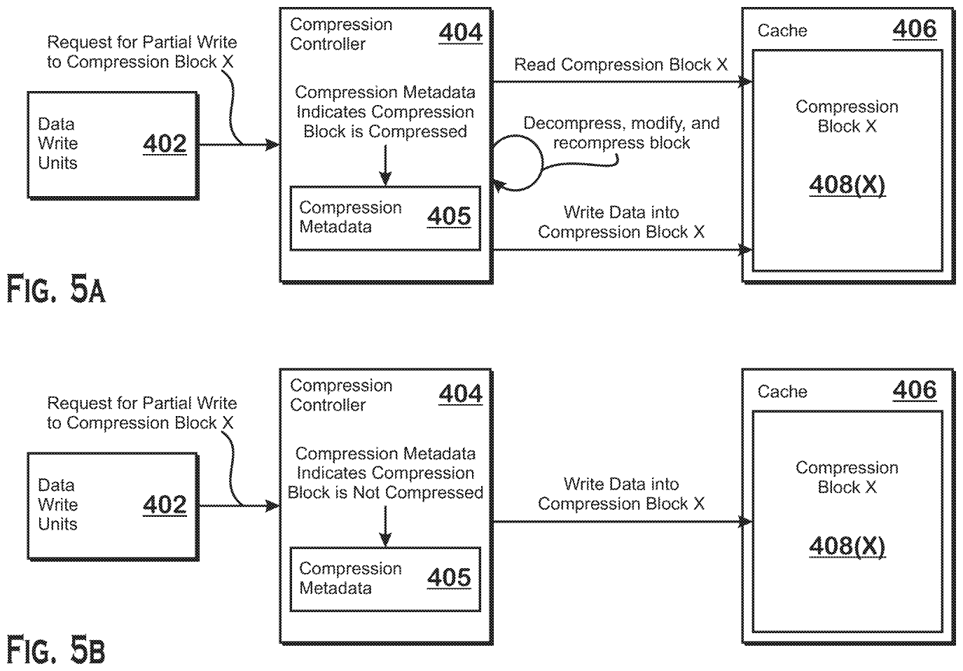

When the compression controller 404 receives a request to perform a partial write from the data write units 402 to a compression block 408 of the compressed data set 407, the compression controller 404 examines the compression metadata 405 to determine whether the compression block 408 is actually compressed. If the compression block 408 is not actually compressed, then the compression controller 404 simply writes the data specified by the partial write request into the compression block 408. If the compression block 408 is compressed, then the compression controller 404 reads the data from the cache 406, decompresses the data, applies the partial write to the decompressed data, recompresses the data, and stores the recompressed data back into the cache 406. These operations are illustrated in FIGS. 5A and 5B.

FIG. 5A illustrates operations of the compression system 400 for a compression block 408 that is compressed, according to an example. The compression controller 404 receives a request for a partial write to compression block X 408(X). In response, the compression controller 404 checks the compression metadata 405, which indicates that the compression block 408(X) is compressed. In response to making this determination, the compression controller 404 reads the compression block 408(X). The compression controller 404 then decompresses the compression block 408(X), modifies the decompressed data by applying the partial write, and recompresses the block to form a new compression block 408. Then the compression controller 404 writes the new compression block 408 back to the cache 406.

FIG. 5B illustrates operations of the compression system 400 for a compression block 408 that is not compressed, according to an example. The compression controller 404 receives a request for a partial write to compression block X 408(X). In response, the compression controller 404 checks the compression metadata 405 and determines that the block is not compressed. In response, the compression controller 404 writes the data specified by the partial write into the compression block. The compression controller 404 does not read the data of the compression block, decompress that data, or recompress that data after the data is modified.

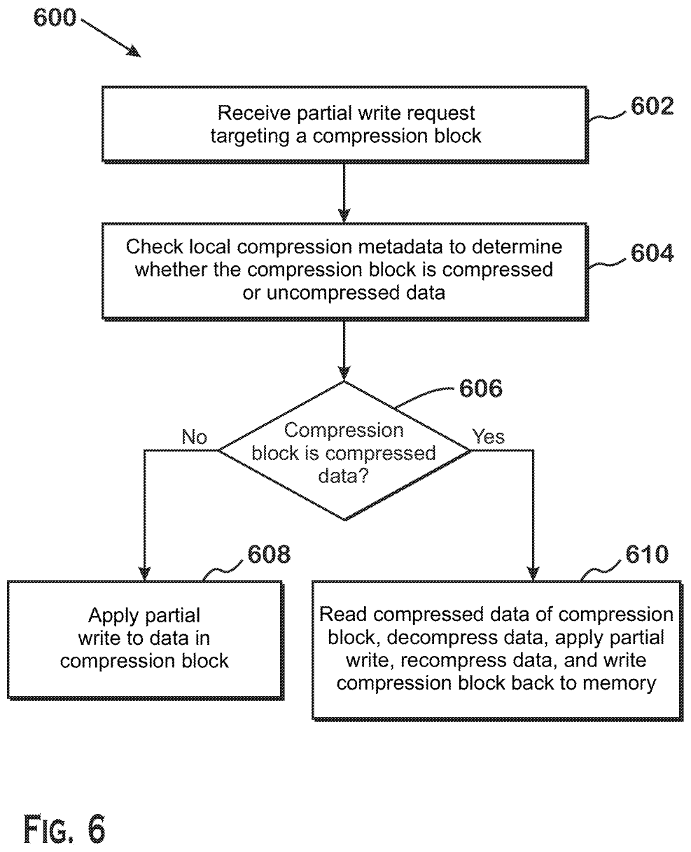

FIG. 6 is a flow diagram of a method 600 for performing a partial write to a compressed data set that stores compression blocks that may be either compressed or uncompressed, according to an example. Although described with respect to the system of FIGS. 1-4 and 5A-5B, those of skill in the art will understand that any system configured to perform the system of the method 600 in any technically feasible order falls within the scope of the present disclosure.

The method 600 begins at step 602, where a compression controller 404 receives a partial write request targeting a compression block. A partial write request is a request to write some, but not all, data in a compression block. At step 604, the compression controller 404 checks a compression metadata 405 to determine whether the compression block is compressed or uncompressed. At step 606, based on the contents of the compression metadata 405, the compression controller 404 determines whether the compression block is compressed data. If the compression block is compressed data, then the method 600 proceeds to step 610. At step 610, in response to the partial write request, the compression controller reads the compressed data of the compression block, decompresses the compressed data, applies the partial write (meaning writes the data specified by the partial write request to the decompressed data), recompresses the data, and stores the recompressed data back to the cache 406 as a modified compression block 408. If, at step 606, the compression block is determined not to be compressed data, then the method 600 proceeds to step 608. At step 608, the compression controller writes the data specified in the partial write request into the compression block.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for performing a partial write to a compression block of a compressed data set, the method comprising:
receiving a request to perform the partial write, the request specifying the compression block stored in a memory and data to be written to the compression block;
reading compression metadata to determine whether the compression block is compressed or uncompressed;
if the compression metadata indicates that the compression block is compressed, then reading the compression block, decompressing the compression block to generate decompressed data, applying the partial write to the decompressed data to generate modified decompressed data, recompressing the modified decompressed data to form a recompressed compression block, and writing the recompressed compression block to the memory; or
if the compression metadata indicates that the compression block is uncompressed, then writing the data into the compression block in the memory.

2. The method of claim 1, wherein the compression block is part of a compressed data set.

3. The method of claim 2, wherein the compressed data set includes a plurality of compression blocks, each of which is generated by applying a compression algorithm to uncompressed data.

4. The method of claim 3, wherein the compression algorithm is configured to store data in an uncompressed format for compression blocks whose uncompressed data, when compressed, results in more data than the uncompressed data.

5. The method of claim 3, wherein the compression algorithm comprises delta color compression.

6. The method of claim 2, wherein the compressed data set comprises a compressed cache.

7. The method of claim 2, wherein the compressed data set comprises a compressed surface.

8. The method of claim 1, wherein the request is received from an output merger stage of a graphics processing pipeline.

9. The method of claim 1, wherein the partial write specifies a write to some, but not all, of the data of the compression block.

10. A compression system for performing a partial write to a compression block of a compressed data set, the compression system comprising:
a compression controller; and
a memory configured to store a compressed data set,
wherein the compression controller is configured to:
receive a request to perform the partial write, the request specifying the compression block stored in a memory and data to be written to the compression block;
read compression metadata to determine whether the compression block is compressed or uncompressed;
if the compression metadata indicates that the compression block is compressed, then read the compression block, decompress the compression block to generate decompressed data, apply the partial write to the decompressed data to generate modified decompressed data, recompress the modified decompressed data to form a recompressed compression block, and write the recompressed compression block to the memory; or
if the compression metadata indicates that the compression block is uncompressed, then write the data into the compression block in the memory.

11. The compression system of claim 10, wherein the compression block is part of a compressed data set.

12. The compression system of claim 11, wherein the compressed data set includes a plurality of compression blocks, each of which is generated by applying a compression algorithm to uncompressed data.

13. The compression system of claim 12, wherein the compression algorithm is configured to store data in an uncompressed format for compression blocks whose uncompressed data, when compressed, results in more data than the uncompressed data.

14. The compression system of claim 12, wherein the compression algorithm comprises delta color compression.

15. The compression system of claim 11, wherein the compressed data set comprises a compressed cache.

16. The compression system of claim 11, wherein the compressed data set comprises a compressed surface.

17. The compression system of claim 10, wherein the request is received from an output merger stage of a graphics processing pipeline.

18. The compression system of claim 10, wherein the partial write specifies a write to some, but not all, of the data of the compression block.

19. A computing device, comprising:
a data write unit; and
a compression system for performing a partial write to a compression block of a compressed data set, the compression system comprising:
a compression controller; and
a memory configured to store a compressed data set,
wherein the compression controller is configured to:
receive a request to perform the partial write from the data write unit, the request specifying the compression block stored in a memory and data to be written to the compression block;
read compression metadata to determine whether the compression block is compressed or uncompressed;
if the compression metadata indicates that the compression block is compressed, then read the compression block, decompress the compression block to generate decompressed data, apply the partial write to the decompressed data to generate modified decompressed data, recompress the modified decompressed data to form a recompressed compression block, and write the recompressed compression block to the memory; or
if the compression metadata indicates that the compression block is uncompressed, then write the data into the compression block in the memory.

20. The computing device of claim 19, wherein the compression block is part of a compressed data set that includes a plurality of compression blocks, each of which is generated by applying a compression algorithm to uncompressed data, wherein the compression algorithm is configured to store data in an uncompressed format for compression blocks whose uncompressed data, when compressed, results in more data than the uncompressed data.
